(19) United States
(12) Patent Application Publication
(10) Pub. No.: US 2026/0309179 A1
(43) Pub. Date: Oct. 8, 2026

(54) JOINING ELEMENT AND METHOD FOR JOINING TWO WORKPIECES

(71) Applicant: Atlas Copco IAS GmbH, Bretten (DE)

(72) Inventors: Lewis JEPPS, Flintshire (GB); Paul BRISKHAM, Flintshire (GB)

(21) Appl. No.: 19/578,447

(22) Filed: Mar. 25, 2026

(30) Foreign Application Priority Data
Apr. 4, 2025 (DE) 10 2025 113 374.3

(51) Int. Cl. F16B 13/02

(52) U.S. Cl. CPC F16B 13/02

(57) ABSTRACT

A joining element for joining two workpieces and a method corresponding thereto are provided. The joining element comprises a head and a cylindrical shaft extending from a bottom of the head. The shaft comprises a base portion extending from the bottom of the head. The shaft comprises a tip portion forming an end of the shaft opposite to the head. The shaft further comprises a rib portion between the base portion and the tip portion. The rib portion comprises a plurality of ribs.

### CROSS-REFERENCE TO RELATED APPLICATIONS

This application claims priority to German Patent Application No. 10 2025 113 374.3, filed on Apr. 4, 2025, which is incorporated by reference herein in its entirety.

### TECHNICAL FIELD

The present invention relates to a joining element for joining, in particular hole-forming joining, at least two workpieces, a method corresponding thereto, and a use of the joining element in a hole-forming joining method, in particular a flow drill fastening method or a flow drill screwing method.

### TECHNICAL BACKGROUND

Joining elements are known and are used to join workpieces, elements or components to one another. In the case of thread-forming joining elements, prior to the joining, no material is removed from a workpiece in order to produce a thread for the joining element, but instead the material of the workpiece is formed or deformed such that the thread is produced in the workpiece. However, when a thread-forming joining element is inserted, a small amount of material is removed from the workpiece. Some thread-forming joining elements are also able to form a hole in the workpiece in which the joining element is arranged. The hole can be formed at the same time as the thread. Thread-forming joining elements, which can also form holes, can be referred to as thread-forming and hole-forming or hole-forming joining elements.

In order to insert a hole-forming joining element into a workpiece, the fastening element is rotated while it is in contact with a first workpiece, such that the first workpiece and indirectly the second workpiece are heated. Subsequently, the joining element is inserted into the first workpiece, pressed through the first workpiece and inserted into the second workpiece. The threaded joining element is rotated during the entire joining operation. As a result, a thread is formed in the workpieces.

The joining element and the workpieces to be joined can be matched to one another such that a surface of the second workpiece is not pierced by the joining element. In the region of the joining element, a bulge then forms in the non-pierced surface.

WO 2023 214 164 A1 discloses a thread-forming and hole-forming joining element. The joining element comprises a head and a shaft defining a longitudinal axis. The shaft comprises a shaft portion and a tip portion. The shaft portion extends from the head. The tip portion extends from the shaft portion and is arranged opposite to the head. At least a part of the shaft portion is provided with a thread.

It has been found that, when the thread-forming joining element is inserted, the start of the thread portion of the joining element can act like a knife and can produce long, thread-shaped material chips. These chips can wrap around the head of the joining element and prevent the complete insertion of the joining element.

In the case of machining tools, it is known to arrange a so-called chip breaker, which causes the chips to bend and break, in order to comminute chips.

However, the chips, which can be produced in the course of a hole-forming joining method, in particular a flow drill screwing method, can be broken or divided into relatively small pieces only with difficulty, since they are produced in a hot process and are therefore very stretchable.

DE 10 2010 046 318 A1 relates to a joining element which does not have a thread, but itself has to be deformed during the joining process in order to produce a secure joining joint between two joining parts lying against one another.

KR 10 2004 0090612 A relates to a riveting method, in which the material is melted locally. The riveting method is carried out as a two-sided joining method.

WO 02/062518 A1 relates to a fastening element which deforms together with the workpiece, using a material of similar hardness.

### SUMMARY OF THE INVENTION

There is therefore a need for a joining element which at least partially reduces the above-described problems from the prior art. Furthermore, it is an object to specify a joining element, the use of which makes it possible to avoid long material chips during flow drill fastening. Furthermore, it is an object to specify a joining element which ensures a more secure joining of two workpieces. In addition, there is a need for a method corresponding to the joining element.

At least one of the above technical objects is achieved by a joining element or by a joining method according to the independent claims. Further embodiments are specified in the dependent claims.

In an independent aspect of the invention, a joining element for joining two workpieces is provided. The joining element comprises a head and a cylindrical shaft extending from a bottom of the head. The shaft comprises a base portion extending from the bottom of the head. The shaft comprises a tip portion forming an end of the shaft opposite to the head. The shaft further comprises a rib portion between the base portion and the tip portion. The rib portion comprises a plurality of ribs.

In a further independent aspect of the invention, a joining element for hole-forming joining two workpieces is provided. The joining element comprises a head and a cylindrical shaft extending from a bottom of the head. The shaft comprises a base portion extending from the bottom of the head. The shaft comprises a tip portion forming an end of the shaft opposite to the head. The shaft further comprises a rib portion between the base portion and the tip portion. The rib portion comprises a plurality of ribs, each rib surrounding the shaft in a respective plane and comprising a constant rib protrusion. The planes are each parallel to each other. The rib portion covers at least 30% of the shaft.

In a further independent aspect of the invention, a method for hole-forming joining two workpieces is provided. The method comprises: providing a first workpiece, a second workpiece and a joining element according to one aspect of the present disclosure; placing the joining element on a surface of the first workpiece; rotating the joining element at a predetermined rotational speed; and exerting a predetermined axial force on the joining element in the direction of the surface of the first workpiece.

In a further independent aspect of the invention, a use of a joining element according to one of the aspects of the present disclosure in a flow drill fastening method is provided.

The core of the invention is to cover at least a substantial part of the shaft, for example at least 30%, by a plurality of parallel ribs of a rib portion, instead of the usually provided thread. The joining element thereby at least partially loses its screw character. In contrast to the groove of a thread, the grooves between two respectively adjacent ribs or rib projections are limited to a circumferential length of the shaft. As a result, in a hole-forming joining method, shorter chips are inherently produced than in a thread. Despite the at least partial replacement of the thread, the joining element can continue to be used in one-sided joining methods, such as the flow drill fastening method. Neither the plurality of ribs nor the grooves formed therebetween have a helical shape. As a result, a chip face, such as in a thread, can be avoided. Experiments have shown that the functionality of the joining element is maintained in comparison with a threaded joining element, as described, for example, in WO 2023/214164 A1. The deformed material of the two workpieces can flow into the grooves between two respectively adjacent ribs. It has furthermore been found that the plurality of ribs ensure a locking interface, comparable to a thread, in the joint of the two workpieces and can additionally reduce the risk of incomplete insertion of the joining element and can protect against vibration loosening. In other words, as a result of the at least partial replacement of the thread of a joining element by a plurality of ribs, it is possible to prevent the thread from acting as a cutting device and producing long, thread-shaped material residues, and to prevent the joining element from becoming detached or manipulated as a result of vibration. On account of the non-helical grooves between the plurality of ribs, any formed material threads cannot be pulled off and, for example, wrap around the head of the joining element.

The joining element and/or the method or the use of the joining element can furthermore comprise one or more of the following features:

Each rib of the rib portion can surround the shaft in a respective plane.

At least one of the ribs can be substantially perpendicular to the shaft axis.

Each rib of the rib portion can comprise a constant rib protrusion and/or a constant rib diameter.

The ribs can each be formed parallel to each other. Planes in which the ribs surround the shaft can each be oriented parallel to each other.

The rib portion can cover at least 30% of the shaft, preferably cover 50% of the shaft.

The rib portion can completely cover the shaft between the base portion and the tip portion. The rib portion can completely cover a region between the base portion and the tip portion. The shaft can be completely grooved between the base portion and the tip portion, i.e., not have a smooth portion. The rib portion can cover at least 40%, preferably at least 50%, more preferably at least 60% of the shaft between the base portion and the tip portion. All ribs of the rib portion can surround, in particular completely surround, the shaft in a respective plane and can each comprise a constant rib protrusion or comprise an identical rib diameter. The rib diameter can correspond or be identical to an outer diameter of the shaft.

The two workpieces can each be flat workpieces which can directly contact each other through a planar contact surface. The joining element is preferably introduced or inserted in the region of the planar contact surface into the two workpieces arranged on top of each other.

The shaft can be formed from a material which is harder, preferably at least 50% harder, than the materials of the two workpieces. The term “hardness” denotes a mechanical resistance which a material or the workpieces oppose the mechanical penetration of another body, for example of the joining element. This difference in hardness between the shaft and the workpieces to be joined can ensure better control of the material displacement in the workpieces and a stronger joint of the two workpieces.

The base portion can have, in a region which adjoins the rib portion, a diameter which corresponds or is equal to the diameter of the ribs or of the rib portion. The tip portion can have, in a region which adjoins the rib portion, a maximum diameter. The maximum diameter of the tip portion can be smaller than the diameter of the ribs or of the rib portion. In other words, an outer shell of the shaft can taper in the transition from the rib portion to the tip portion. As a result, the material displacement in the first workpiece and/or second workpiece can be improved.

A constant rib protrusion can mean that the rib has the same height in relation to the shaft in the circumferential direction around the shaft. Each rib can comprise a circular cross section. Each rib can be rotationally symmetrical in relation to the axis of rotation of the joining element. The shaft can comprise a circular cross section and/or be rotationally symmetrical in relation to the axis of rotation of the joining element.

The joining element can be inserted into the two workpieces on one side, i.e. without support of a second component on a side opposite to the joining element in relation to the two workpieces.

The joining element can further comprise a threaded portion arranged between the rib portion and the base portion. The threaded portion can comprise a thread, in particular an external thread. The threaded portion can be formed on the shaft closer to the head in the axial direction than the rib portion. The rib portion can directly adjoin the tip portion. As a result, long material chips can be equally effectively avoided, wherein the threaded portion can produce an additional clamping effect in a region close to the head of the joining element. Advantageously, a width of the threaded portion is selected corresponding to, in particular equal to, a thickness of the first workpiece. As a result, the threaded portion can more effectively secure the first workpiece in relation to the second workpiece in the formed joint.

The ribs can comprise a symmetric rib profile. Each rib can comprise a symmetric rib profile. The term “rib profile” relates to a longitudinal section through one or more rib projections lying against one another. Each rib or each rib projection can comprise a first flank and a second flank. A symmetric rib profile can mean that the first flank is mirror-symmetrical to the second flank in the longitudinal section. The plane in which the respective rib is formed can serve as a mirror plane. The mirror plane can lie perpendicularly to an axis of rotation of the joining element or intersect the axis of rotation at an angle not equal to 90°.

The axis of rotation of the joining element can be coaxial to the longitudinal axis of the shaft.

The ribs can comprise an asymmetric rib profile. Each rib can comprise an asymmetric rib profile. A first flank of the rib projection can face the head. A second flank of the rib projection can face the tip portion. The first flank can intersect a plane, which intersects both flanks and is parallel to the rib, at a first angle. The first angle can be smaller or larger than a second angle, at which the second flank intersects the plane. In other words, the ribs can comprise a sawtooth shape in the longitudinal section. The asymmetric rib profile can improve the material flow in the two workpieces or the material displacement in the two workpieces and increase the pull-out or tear-out resistance.

The rib portion, individual ribs and/or each rib can comprise a trapezoidal shape in a longitudinal section. Alternatively, or additionally, the rib portion, individual ribs and/or each rib can comprise a round shape, a sawtooth shape and/or a triangular shape in the longitudinal section.

A circumferential groove can be formed between each two ribs. Each groove can comprise a constant groove depth. The groove depths can vary along an axial direction of the shaft, in particular increase in the direction of the tip portion. This can mean that a deeper groove is formed between two ribs which are positioned closer to the tip portion than two further adjacent ribs, i.e. between the two further adjacent ribs. An outer diameter of the ribs can be identical for all ribs. A diameter of the shaft can vary in the axial direction, in particular be conical or taper. This can result in different groove depths for different axial positions of the grooves.

The rib projections or the ribs can comprise a first round shape in a longitudinal section and/or grooves can comprise a second round shape in the longitudinal section between the ribs. The second round shape can comprise a curvature opposite to the first round shape. The first round shape and the second round shape can comprise a curvature identical in amount. In other words, the ribs and/or the grooves can be rounded or rounded.

A groove with a first groove width can be formed between each two ribs. At least one of the grooves can comprise a second groove width, which is larger than the first groove width. One of the grooves with the second groove width can preferably connect the tip portion to the groove portion. In other words, the grooves of the rib portion can comprise a mixture of large and small grooves. It can be advantageous if the tip portion and the rib portion are connected by a groove which is larger in comparison with the other grooves, i.e. wider and/or deeper groove, in order to reduce the penetration resistance of the joining element into the two workpieces.

The axis of rotation of the joining element can intersect the planes of the ribs perpendicularly or at an angle not equal to 90°. This means that the ribs of the rib portion can be positioned horizontally or obliquely, but not mixed horizontally and obliquely. Obliquely positioned ribs differ from a thread in that separate grooves are respectively formed between the plurality of ribs, while the thread comprises only a single groove.

The tip portion can comprise no grooves, no thread and no ribs.

The head can further comprise an undercut. The undercut can adjoin the shaft and in particular extend around the latter. The undercut can be configured to receive material from the first workpiece and/or the second workpiece when the joining element is used.

The head can further comprise a hexagonal device by means of which a joining tool can transmit a torque to the joining element.

The tip portion can comprise a conical shape in order to form the largest possible contact surface with the first workpiece when placed on the surface of the first workpiece. A friction between the joining element and the first workpiece is caused by a rotation of the joining element and by exerting an axial force on the joining element. The joining element penetrates into the first workpiece depending on the axial force and depending on the material properties of the first workpiece. When the joining element has penetrated so deeply into the first workpiece or into the first workpiece and the second workpiece that the grooves of the groove portion come into contact with the first workpiece, a groove profile corresponding to the grooves of the groove portion is formed in the first workpiece and/or in the second workpiece when the joining element penetrates further.

As a result of the rotation of the joining element, the first workpiece and, via this, the second workpiece are heated. In this case, the rotation is configured to heat the first workpiece and/or the second workpiece only to process temperatures of approximately 300° C. The first workpiece and/or the second workpiece can comprise aluminum which has a melting temperature of 660° C. It can be ensured that the process temperature remains below the melting temperature of the first workpiece and/or of the second workpiece, that is to say no melting of the first workpiece or of the second workpiece takes place. As a result, the material of the first workpiece and/or of the second workpiece remains around and below the recrystallization temperature in the region of the hot forming, as a result of which the problems associated with the hot forming, such as grain growth and the loss of local mechanical properties, are avoided, while at the same time the ductility is improved in comparison with the cold forming.

Preferably, the first workpiece and/or the second workpiece does not have a hole in a region of the first or second workpiece which is axially aligned with the axis of rotation of the joining element before or when the joining element is placed on the surface of the first workpiece. That is to say, the joining element can be introduced into the first and second workpiece without pre-punching of the first and/or second workpiece.

The tip portion can be surrounded by the first and/or second workpiece if the first and second workpiece are joined to one another. In particular, the tip portion can be surrounded by the first and/or second workpiece if the joining element has penetrated into the first and second workpiece to its final depth. If the first and second workpiece are joined to one another or if the joining element has penetrated into the first and second workpiece to its final depth, the tip portion cannot protrude out of the first and/or second workpiece. The tip portion can be at least partially surrounded by a bulge formed in the second workpiece. If the first and second workpiece are joined to one another or if the joining element has penetrated into the first and second workpiece to its final depth, a surface of the second workpiece cannot be pierced by the joining element.

The first workpiece and/or the second workpiece can be a component. In particular, the first workpiece and/or the second workpiece can comprise metal or consist of metal. Preferably, the first workpiece is a metal element or a metal component, in particular a steel element or a steel component. The first workpiece can likewise be an aluminum component. The aluminum component can consist of or comprise an AA5000, AA6000 or AA7000 alloy. The second workpiece can be a metal element or a metal component, in particular an aluminum element or aluminum component. Particularly preferably, the second workpiece is an aluminum die-cast element. The second workpiece can be a non-heat-treated aluminum die-cast element. Likewise, the second workpiece can be an aluminum die-cast element with a high proportion of secondary aluminum, i.e. a high proportion of recycled aluminum. The second workpiece can consist of or comprise an AA7000 alloy.

### BRIEF DESCRIPTION OF THE FIGURES

The invention or further embodiments and advantages of the invention are explained in more detail below with reference to drawings, wherein the drawings describe only embodiments of the invention. Identical components are provided with the same reference signs in the drawings. Elements which are drawn with dashed lines are considered to be optional elements.

FIG. 1 shows a perspective side view of a first example of a joining element according to embodiments of the disclosure.

FIG. 2A shows a longitudinal section through the joining element of FIG. 1.

FIG. 2B shows an enlarged region of the longitudinal section of FIG. 2A.

FIG. 3A shows a longitudinal section through a second example of the joining element according to embodiments of the present disclosure.

FIG. 3B shows an enlarged region of the longitudinal section of FIG. 3A.

FIG. 4 shows a longitudinal section through a third example of the joining element according to embodiments of the present disclosure.

FIG. 5 shows a longitudinal section through a fourth example of the joining element according to embodiments of the present disclosure.

FIG. 6 shows a longitudinal section through a fifth example of the joining element according to embodiments of the present disclosure.

FIG. 7 shows a longitudinal section through a sixth example of the joining element according to embodiments of the present disclosure.

FIG. 8A shows a perspective side view of a seventh example of the joining element according to embodiments of the present disclosure.

FIG. 8B shows a longitudinal section through the joining element of FIG. 8A.

FIG. 9A shows a perspective side view of an eighth example of the joining element according to embodiments of the present disclosure.

FIG. 9B shows a longitudinal section through the joining element of FIG. 9A.

FIG. 10 shows an illustration of a longitudinal section through a joining element after its use in a method according to embodiments of the disclosure.

### DETAILED DESCRIPTION

In the following, unless stated otherwise, the same reference signs are used for identical and identically acting elements. The illustrated elements are not to be regarded as true to scale, rather individual elements can be illustrated with an exaggerated size for better understanding.

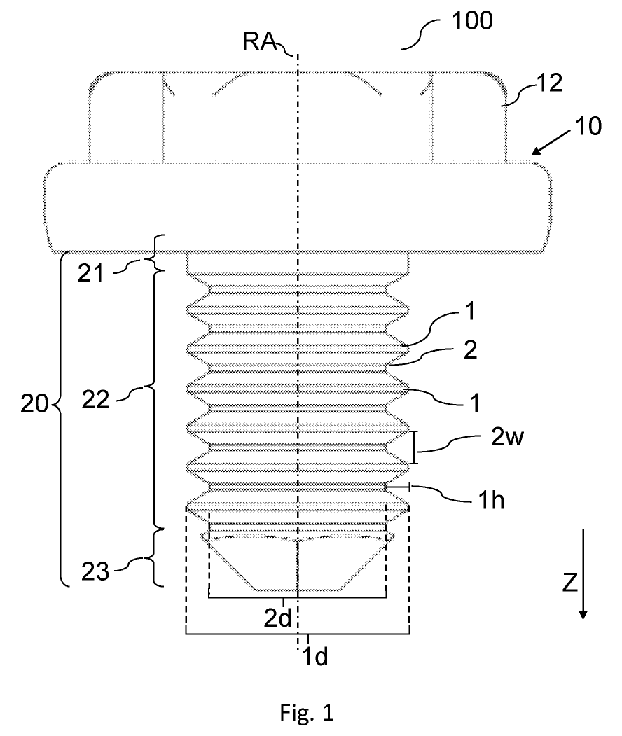

FIG. 1 illustrates a first example of a joining element 100 according to embodiments of the disclosure. The joining element 100 has a head 10 and a shaft 20. The shaft 20 extends from the head 10, more precisely from a bottom of the head 10. The head can comprise a hexagonal device 12 for coupling the joining element 100 to a joining tool.

The shaft 20 in the example of FIG. 1 can be divided into three regions. A base portion 21 is formed directly adjoining the bottom of the head 10 and extending therefrom. The base portion 21 is preferably formed rotationally symmetrical in relation to the axis of rotation RA.

Adjoining the base portion 21, a rib portion 22 follows in the axial direction Z. The rib portion 22 comprises a plurality of ribs 1, wherein a groove 2 can be formed between two respectively directly adjacent ribs 1. In the example of FIG. 1, the ribs 1, more precisely each rib 1, comprise a trapezoidal shape. In the trapezoidal shape, the smaller base side can be substantially smaller than the larger base side. The ribs 1 comprise a rib protrusion 1h, which can also be referred to as rib height. The rib protrusion 1h or the rib height corresponds to a groove depth. The grooves 2 further comprise a groove width 2w, which can be defined between the two tips of the ribs 1 forming a groove 2. In the example of FIG. 1, all ribs 1 are formed in the same way. The ribs 1 are each formed parallel to each other and perpendicularly to the axis of rotation RA. Each rib 1, and therefore the rib portion 22 as such, has a diameter 1d, which can be larger than an (inner) diameter 2d of the shaft 20, which corresponds to the diameter of the grooves 2. The reference sign “1d” therefore denotes a rib diameter and the reference sign “2d” denotes a groove diameter. The grooves 2, the ribs 1 and the rib portion 22 can be formed rotationally symmetrical to the axis of rotation RA.

The base portion can have a diameter which corresponds to the diameter 1d of the ribs 1.

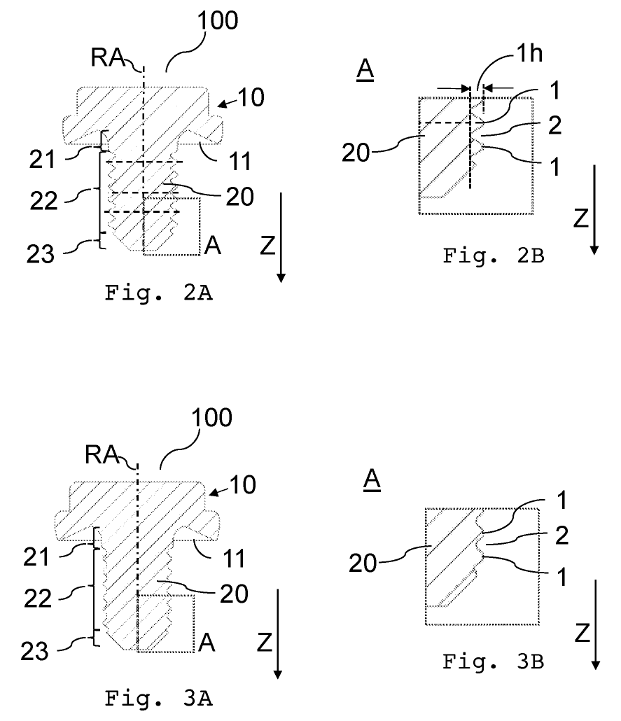

FIG. 2A illustrates the example of the joining element 100 of FIG. 1 in a longitudinal section.

To clarify the parallel planes in which the ribs 1 are each formed, dashed lines are drawn in FIG. 2A through the ribs 1.

In the longitudinal section of FIG. 2A, in comparison to FIG. 1, an undercut 11 of the head 10 can additionally be seen, from which undercut the base portion 21 extends.

A detail A of the shaft 20 is shown in FIG. 2B. Therein, the ribs 1 and the grooves 2 formed between the ribs 1 are highlighted in the longitudinal section view. In the example of FIGS. 1, 2A and 2B, each rib 1 can comprise the same rib protrusion 1h. In the enlargement of FIG. 2B, it can be clearly seen that the maximum diameter of the tip portion 23, which directly adjoins the rib portion 22, can be smaller than the diameter 1d of the ribs 1, but larger than the diameter 2d of the grooves 2. As a result, the tip portion 23 can be tapered with respect to the rib portion 22.

FIGS. 3A and 3B illustrate a second example of a joining element 100. Analogously to FIG. 2B, FIG. 3B illustrates an enlarged detail A of FIG. 3A.

The joining element 100 in the example of FIGS. 3A and 3B has rounded ribs 1 and grooves 2 in comparison with the joining element 100 in the example of FIGS. 1, 2A and 2B. This means that the rib portion 22 comprises a round shape in the longitudinal section. The curvature of the round shape of the ribs 1 can be substantially opposite to the curvature of the round shape of the grooves 2. The remaining properties and features of the joining element from FIGS. 3A and 3B apply analogously to that described with respect to FIGS. 1, 2A and 2B.

In the enlargement of FIG. 3B, the round shape of the rib portion 22 is found in comparison with the trapezoidal shape of FIG. 2B.

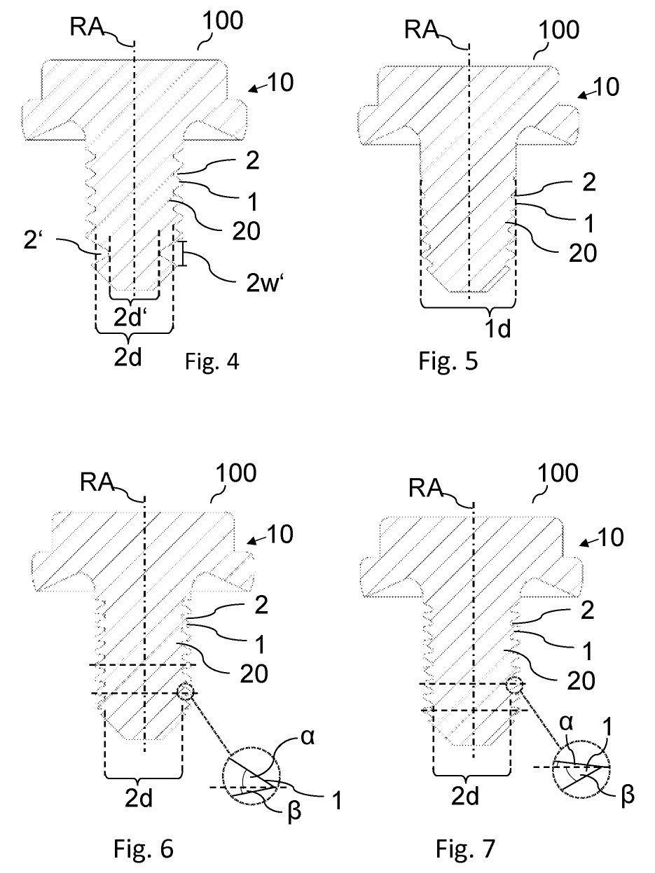

FIG. 4 illustrates a third example of a joining element 100. In the example of FIG. 4, the rib protrusion 1h can vary along the axial direction Z in comparison with the example of FIGS. 1, 2A and 2B. That is to say, in this configuration, the grooves 2, 2′ can comprise different groove diameters 2d, 2d′ and/or different groove widths 2w, 2w′. Grooves 2, 2′ with different groove diameters 2d, 2d′ and/or different groove widths 2w, 2w′ can be mixed in the rib portion 22.

A first groove 2 and a second groove 2′ can be formed between each two ribs 1. The first groove 2 can comprise a first groove width 2w, the second groove 2′ can comprise a second groove width 2w′. Preferably, the tip portion 23 and the rib portion 22 are connected by a second groove 2′. In other words, the last groove 2 in the axial direction Z is preferably a second groove 2′. It is further advantageous if two, three or four second grooves 2′ are formed, in particular in a half of the rib portion 22 which is positioned closer to the tip portion 23 than to the base portion 21.

FIG. 5 illustrates a fourth example of a joining element 100. In the example of FIG. 5, each groove 2 can comprise a different groove diameter 2d, while the rib diameter 1d can be identical for all ribs. In particular, the groove diameter 2d can continuously reduce or taper in the axial direction Z for successive grooves 2. The (inner) diameter of the shaft 20 can comprise a conical shape. The rib protrusion 1h of the ribs 1 can increase, in particular continuously increase, in the axial direction Z for successive ribs 1. As a result, the grooves 2 which are positioned closer to the tip portion 23 and penetrate deeper into the at least two workpieces can receive more deformed material of the workpieces than grooves 2 which are positioned closer to the base portion 21. The penetration resistance of the joining element 100 into the two workpieces can thus be reduced.

FIG. 6 illustrates a fifth example of a joining element 100. In the example of FIG. 6, the rib portion 22, a rib 1 and/or each of its ribs 1 can comprise an asymmetric rib profile, in particular a sawtooth shape. As illustrated in more detail in the circular enlargement portion, a first flank of the rib 1 can face the base portion 21 or the head 10 and a second flank can face the tip portion 23. Furthermore, the plane in which the rib protrusion 1h has its maximum extent is drawn in a dashed manner. In the longitudinal section of FIG. 6, the first flank and the second flank intersect as well as the plane. In this case, the first flank can meet the plane more steeply than the second flank. In other words, the first flank can form a first angle α with the plane and the second flank can form a second angle β with the plane. The first angle α can be larger than the second angle β. Alternatively, as illustrated in FIG. 7, the first angle α can be smaller than the second angle β. In the case of a symmetric rib profile, such as in FIGS. 1, 2A and 2B, for example, the first angle α and the second angle β can be of equal size.

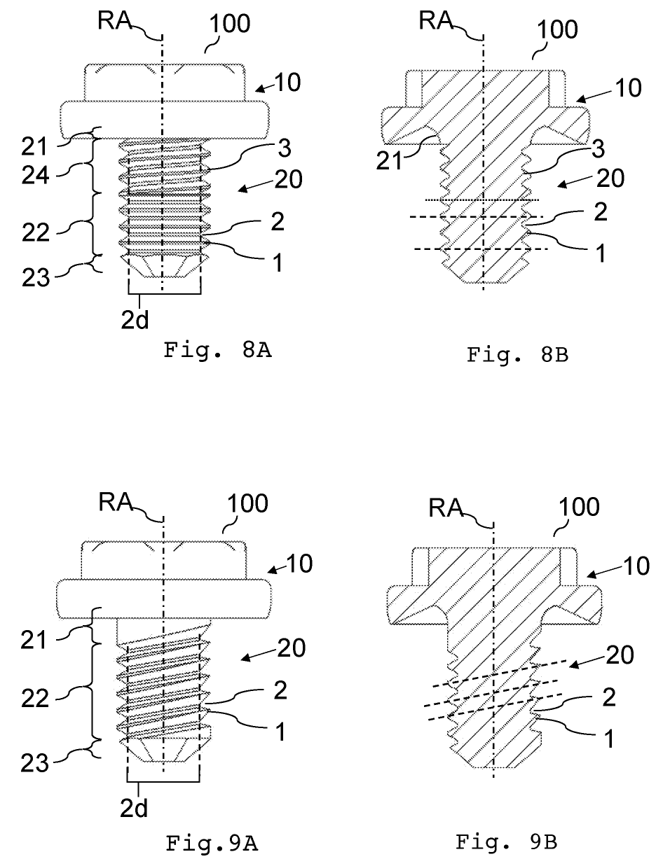

FIGS. 8A and 8B illustrate a seventh example of a joining element 100. In contrast to all other examples described according to embodiments of the disclosure, the joining element 100 can comprise a shaft 20 which, in addition to the rib portion 22, also comprises a threaded portion 24. The threaded portion 24 can comprise a thread, in particular an external thread, that is to say a single groove. The rib portion 22 can be configured as described with reference to FIGS. 1-7, 9A and 9B. The rib portion 22 can be positioned closer to the tip portion 23 than the threaded portion 24. In other words, the rib portion 22 can extend from the threaded portion 24 in the axial direction Z.

FIG. 8B shows a longitudinal section corresponding to FIG. 8A, in which the transition from the threaded portion 24 to the rib portion 22 is indicated by a dotted line. Furthermore, a selection of the parallel planes in which the ribs 1 surround the shaft 20 is indicated by a dashed line.

FIGS. 9A and 9B illustrate an eighth example of a joining element 100. In the example of FIG. 9A, the parallel planes in which the ribs 1 surround the shaft 20 are inclined with respect to the head 10. The ribs 1 or their corresponding planes can form an angle not equal to 90° with the axis of rotation RA. The axis of rotation RA can intersect the planes of the ribs at an angle not equal to 90°. Unlike in a thread, each rib 1 is formed in its own plane, wherein the ribs 1 or the planes are positioned parallel to each other. A selection of these planes is indicated by dashed lines in the longitudinal section of FIG. 9B. The groove diameter 2d can be constant in the rib portion 22 of FIGS. 9A, 9B in the axial direction Z. For the sake of clarity, the axial direction is not indicated in FIGS. 4-9A and 9B—but it results analogously to FIG. 1.

In the examples of FIGS. 1-7, 9A and 9B, the rib portion 22 can completely cover the shaft 20 between the tip portion 23 and the base portion 21. The shaft 20 can thereby be completely thread-free.

Although individual features of the rib portion 22 are described in different examples of the joining element 100, a joining element 100 can comprise combinations of the described features. Thus, the ribs 1 of FIGS. 4 and 5 can comprise a round shape in the longitudinal section. Furthermore, the sawtooth shape of FIGS. 6 and 7 can be combined with alternating groove widths 2w, 2w′ according to FIG. 4 and/or comprise a varying groove diameter according to FIG. 5.

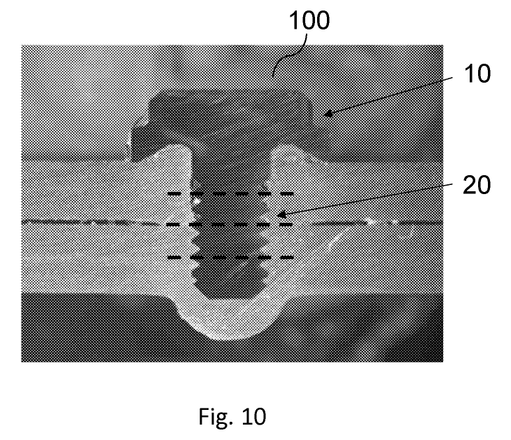

FIG. 10 illustrates an illustration (photo) of a longitudinal section through a joining element 100 after its use in a method according to embodiments of the disclosure.

In a first step, a first workpiece, a second workpiece and a joining element 100 (as described above) were provided. The first workpiece and the second workpiece can be planar workpieces, as shown in FIG. 10. The first workpiece can rest on the second workpiece. None of the workpieces had a hole or any recess at the joining point, as shown in FIG. 10.

In a second step, the joining element 100 was placed on a surface of the first workpiece. The joining element 100 can be placed on the first workpiece by a joining tool, in particular by means of a hold-down device. As a result, the joining element 100 can directly contact the surface of the first workpiece. The joining element 100 can be placed on one side, i.e. without an auxiliary structure or the like, on the opposite side of the second workpiece.

In a third step, the joining element 100 was set into a rotational movement at a predetermined rotational speed. On account of the direct contact between the joining element 100 and the first workpiece and a frictional force resulting therefrom, the first workpiece is heated as a result of the rotation. Heating of the first workpiece to a maximum of 300° C. can be provided as the process temperature.

In a fourth step, a predetermined axial force was exerted on the joining element 100 in the direction of the surface of the first workpiece. As a result, the joining element 100 can be pressed into the first workpiece and subsequently into the second workpiece. Exemplary ranges for the predetermined rotational speed and the predetermined axial force can be found, for example, in DE 10 2024 110 303 A1.

The joining element 100 has not yet been fully pushed through the second workpiece. Instead, a bulge has formed, such that the shaft 20 of the joining element 100 is completely embedded in the two workpieces.

By means of the joining element according to the invention, in a hole-forming joining method, shorter chips are inherently produced than in a joining element in which a thread adjoins the tip portion. Neither the plurality of ribs 1 nor the grooves 2 formed therebetween have a helical shape. As a result, a chip face, such as in a thread, can be avoided, such that thread-shaped material residues are reduced, and thus the risk that the joining element can become detached or manipulated as a result of vibration.

What is claimed is:

1. A joining element for joining two workpieces, the joining element comprising:
a head; and
a shaft extending from a bottom of the head, the shaft comprising:
a base portion extending from the bottom of the head;
a tip portion forming an end of the shaft opposite to the head; and
a rib portion between the base portion and the tip portion, the rib portion comprising a plurality of ribs.

2. The joining element of claim 1, wherein each rib of the rib portion surrounds the shaft in a respective plane.

3. The joining element of claim 1, wherein each rib of the rib portion is perpendicular to a shaft axis.

4. The joining element of claim 1, wherein each rib of the rib portion comprises a constant rib protrusion or a constant rib diameter.

5. The joining element of claim 1, wherein the ribs are each formed parallel to each other or planes in which the ribs surround the shaft are each parallel to each other.

6. The joining element of claim 1, wherein the rib portion covers at least 30% of the shaft.

7. The joining element of claim 1, wherein the rib portion covers 50% of the shaft.

8. The joining element of claim 1, further comprising a threaded portion arranged between the rib portion and the base portion.

9. The joining element of claim 1, wherein the ribs comprise an asymmetric rib profile.

10. The joining element of claim 1, wherein the rib portion comprises a trapezoidal shape in a longitudinal section.

11. The joining element of claim 1, wherein a circumferential groove is formed between each two ribs, wherein each circumferential groove comprises a constant groove depth, wherein a depth of the circumferential grooves vary along an axial direction of the shaft, in particular increase in the direction of the tip portion.

12. The joining element of claim 1, wherein the rib portion completely covers a region between the base portion and the tip portion.

13. The joining element of claim 1, wherein the ribs comprise a first round shape in a longitudinal section or circumferential grooves comprise a second round shape in the longitudinal section between the ribs, wherein the second round shape comprises a curvature opposite to the first round shape.

14. The joining element of claim 13, wherein the first round shape and the second round shape comprise a curvature identical in amount.

15. The joining element of claim 1, wherein a groove with a first groove width is formed between each two ribs, wherein at least one of the grooves comprises a second groove width, which is larger than the first groove width.

16. The joining element of claim 15, wherein one of the grooves with the second groove width connects the tip portion to the groove portion.

17. The joining element of claim 1, wherein an axis of rotation of the joining element intersects planes of the ribs perpendicularly or at an angle not equal to 90°.

18. A method for producing a hole-forming joint of two workpieces, the method comprising:
providing a first workpiece, a second workpiece and a joining element according to claim 1;
placing the joining element on a surface of the first workpiece;
rotating the joining element at a predetermined rotational speed; and
exerting a predetermined axial force on the joining element in a direction of the surface of the first workpiece.

19. The method of claim 18, wherein the method is a flow drill fastening method.
